(19) United States
(12) Patent Application Publication
(10) Pub. No.: US 2020/0400205 A1
(43) Pub. Date: Dec. 24, 2020

(54) SPRING

(71) Applicant: CHUO HATSUJO KABUSHIKI KAISHA, Nagoya-shi, Aichi (JP)

(72) Inventors: Hiroyuki OGISO, Nagoya-shi, Aichi (JP); Kazuyoshi NONO, Nagoya-shi, Aichi (JP); Hideo YAMASHITA, Nagoya-shi, Aichi (JP); Yuichi NAKAZAWA, Nagoya-shi, Aichi (JP)

(73) Assignee: CHUO HATSUJO KABUSHIKI KAISHA, Nagoya-shi, Aichi (JP)

(21) Appl. No.: 16/975,386

(22) PCT Filed: Mar. 1, 2019
(86) PCT No.: PCT/JP2019/008210

§ 371 Date: Aug. 24, 2020

(30) Foreign Application Priority Data
Mar. 9, 2018 (JP) 2018-043060

(51) Int. Cl. F16F 1/02; F16F 1/12; F16F 1/06

(52) U.S. Cl. CPC F16F 1/024; F16F 1/06; F16F 1/12

(57) ABSTRACT

Disclosed is a spring for a suspension device for a vehicle. The spring includes: a spring section made of a coil-shaped wire; and a seat section made of an elastically deformable material, brought into contact with a seat turn section of the spring section, and bearing load acting on the spring section. When a direction orthogonal to a direction of the load acting on the spring section is set as a widthwise direction, at least a part of the seat section is provided with a movable region support section having a widthwise dimension less than or equal to predetermined times a diameter dimension of the wire.

### CROSS-REFERENCE TO RELATED APPLICATIONS

This international application claims priority of Japanese Patent Application No. 2018-43060 filed with the Japan Patent Office on Mar. 9, 2018, the contents of which is incorporated herein by reference in their entirety.

### FIELD OF THE INVENTION

The present disclosure relates to a spring, and in particular to a spring that can be used in a suspension device such as a suspension device for a vehicle.

### BACKGROUND ART

For example, in a suspension for a suspension device described in Patent Document 1, a seat section including a rubber seat is arranged between a coil spring and a spring seat made of metal.

### PRIOR ART DOCUMENT

### Patent Document

Patent Document 1: Japanese Patent Publication No. 2014-181776

### SUMMARY OF THE INVENTION

### Problems to be Solved by the Invention

Since the seat section is made of rubber, the seat section is elastically deformed as a function of the magnitude of the load acting on the coil spring (hereinafter referred simply to as load). Therefore, the area of a portion of the seat section that is in contact with the coil spring changes as a function of a change in the load.

For example, if the load becomes larger, the contact area between the seat section and the coil spring becomes larger. If the load becomes smaller, the contact area between the seat section and the coil spring becomes smaller. In other words, a portion that is always in contact with the coil spring and a portion that is in contact with the coil spring only when the load is increased (hereinafter referred to as a contact section) are formed in the seat section.

The seat section is pressed against the coil spring with a large contact surface pressure when it is compressed and deformed, and the contact surface pressure becomes smaller as the seat section is restored. Therefore, the contact section is brought into contact with the coil spring so as to rub against the coil spring according to the change in the load.

Therefore, if the load is changed repeatedly for years, the coil spring is rubbed by the contact section, and the coil spring may be damaged early. More specifically, the protective coating of the coil spring may be damaged early.

The present disclosure discloses an example of a spring that can be used in a suspension device for a vehicle and that is capable of suppressing early damage of a spring section such as a coil spring.

### Means for Solving the Problems

A spring for a suspension device for a vehicle includes: a spring section made of a coil-shaped wire; and a seat section made by an elastically deformable material, wherein the seat section is in contact with a seat turn section of the spring section, and bears load acting on the spring section.

Preferably, when a direction orthogonal to a direction of the load acting on the spring section is set as a widthwise direction, at least a part of the seat section is provided with, for example, a movable region support section, wherein the movable region support section has a widthwise dimension less than or equal to 1.25 times a diameter dimension of the wire.

Thus, the seat section has a structure in which there is substantially no contact section (see FIG. 3). Therefore, according to the spring for a suspension device for a vehicle, rubbing of the coating layer by the contact section is suppressed, so that early damage of the spring section can be suppressed.

### BRIEF DESCRIPTION OF DRAWINGS

FIG. 1 is a diagram showing a spring according to a first embodiment.

FIG. 2 is a diagram showing a seat section in the first embodiment.

FIG. 3 is a diagram showing the seat section in the first embodiment.

FIG. 4 is a diagram illustrating an effect of the seat section in the first embodiment.

### DESCRIPTION OF REFERENCE NUMERALS

1: spring for suspension device,
2: spring section,
2A: wire,
2B: coating layer,
2C: seat turn section,
3: seat section,
3A: groove section,
3C: seat turn section,
Ao: movable region support section.

### DETAILED DESCRIPTION OF THE INVENTION

The following “embodiment” shows an example of an embodiment falling within the technical scope of the present disclosure. In other words, the specific items of the invention which are recited in the claims are not limited by specific configurations, structures, or the like shown in the following embodiments.

In addition, arrows or the like indicating directions marked in the drawings are described for an ease understanding of the relations between the drawings. The present disclosure is not limited by the directions marked in the drawings.

At least a member or portion described with a reference numeral is provided at least one in number unless specified with the term “one” or the like. In other words, two or more such members may be provided if they are not specified with the term “one” or the like in advance.

### First Embodiment

1. Overview of Spring for Suspension Device

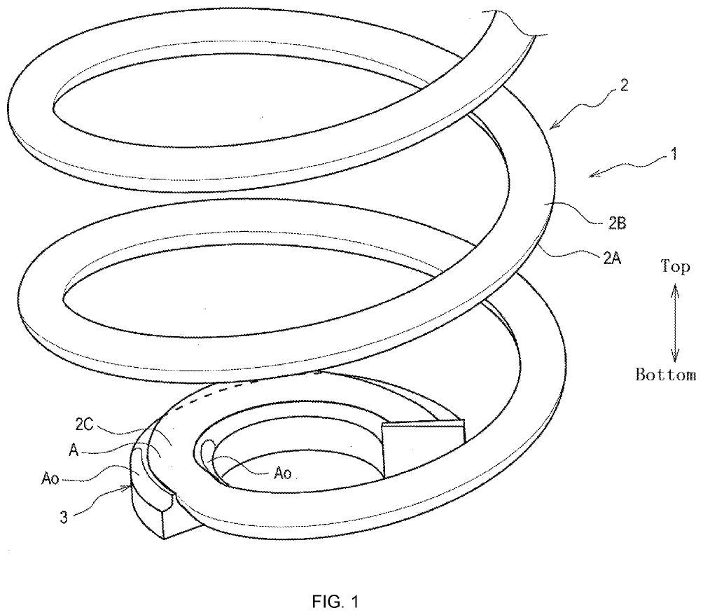

An example of a spring that can be used in a suspension device for front wheels of a vehicle is described in this embodiment. A spring 1 for a suspension device shown in FIG. 1 (hereinafter referred also to as a spring 1) includes a spring section 2 and a seat section 3.

The spring section 2 is a spring formed by a wire 2A made of metal and is a coil spring formed in a coil shape. A coating layer 2B covering the entire wire 2A is formed on the surface of the wire 2A. The coating layer 2B is a thin film formed from a resin such as a thermosetting resin.

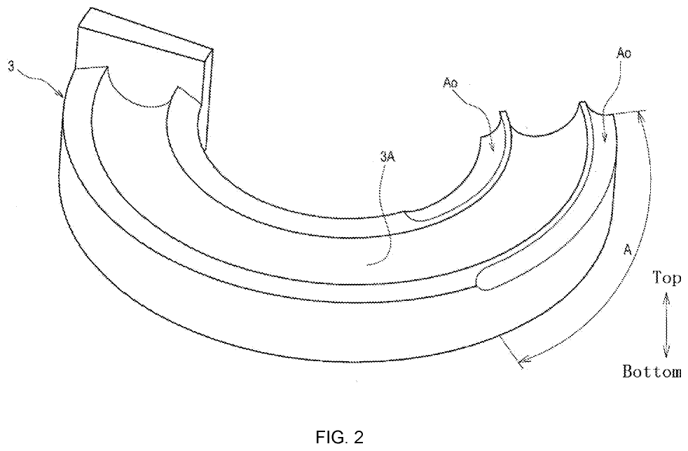

The seat section 3 is an example of a seat for a suspension device which bears load acting on the spring section 2. The seat section 3 is formed by an elastically deformable material. The material of the seat section 3 may exemplarily include rubber, resin, and the like. As shown in FIG. 2, the seat section 3 is provided therein with a groove section 3A into which the wire 2A is fitted.

More specifically, the groove section 3A is a groove for fitting therein a part of the wire 2A constituting a seat turn section (end turn section) 2C (see FIG. 1) is fitted. In other words, the seat section 3 is arranged at an end in the coil axial direction of the spring section 2 formed in a coil shape and the seat section is in contact with the seat turn section 2C.

2. Structure of the Seat Section

As shown in FIG. 2, the seat section 3 thereon is provided with a movable region support section Ao. The movable region support section Ao is arranged at a position corresponding to a movable section A (see FIG. 1) of the seat turn section 2C. The movable section A is a portion deviated from an end portion of the seat turn section 2C by at least 0.55 turns or more.

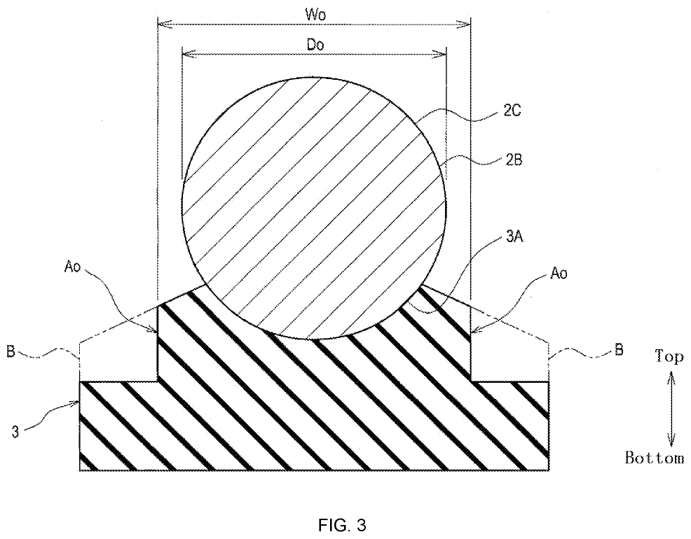

As shown in FIG. 3, a widthwise dimension Wo of the movable region support section Ao is less than or equal to 1.25 times the diameter dimension Do of the wire 2A forming the seat turn section 2C. The widthwise direction refers to a direction orthogonal to a direction (a top-to-bottom direction in FIG. 3) of the load acting on the spring section 2.

3. Features of the Spring for Suspension Device of this Embodiment

Since the seat section 3 is made of rubber, the seat section 3 is elastically deformed as a function of the magnitude of the load acting on the seat turn section 2C (hereinafter simply referred to as load). Additionally, the area of a portion of the seat section 3 that is in contact with the seat turn section 2C changes according to as a function of the load. Specifically, if the load becomes larger, the contact area between the seat section 3 and the seat turn section 2C becomes larger. If the load becomes smaller, the contact area between the seat section 3 and the seat turn section 2C becomes smaller.

Assuming a structure in which the movable region support section Ao is not provided, i.e., a structure shown by double-dot chain lines in FIG. 3, a portion (an inner wall of the groove section 3A) that is always in contact with the seat turn section 2C regardless of presence of the load and a portion (hereinafter referred to as a contact section B) that is in contact with the seat turn section 2C only when the load is increased are formed in the seat section 3.

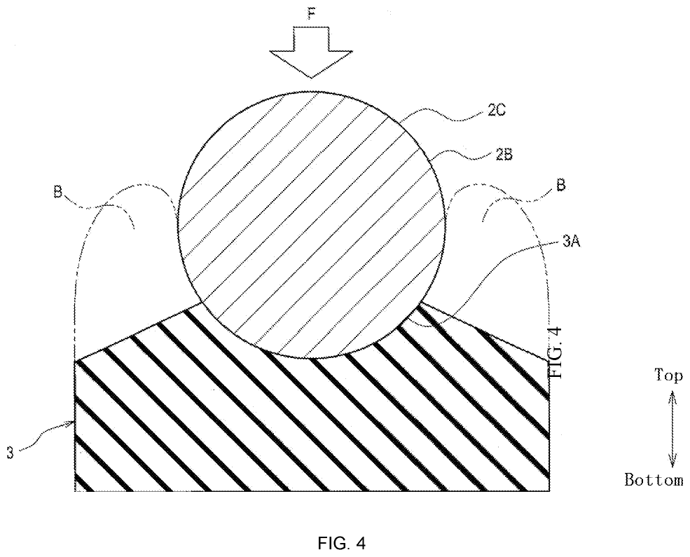

As shown in FIG. 4, if a large load F acts on the seat section 3, the seat section 3 is greatly deformed, so that the contact section B may be pressed against the seat turn section 2C. If the seat section 3 is restored (see FIG. 3), the contact section B is moved away from the seat turn section 3C, and the pressure at the contact surface between the seat section 3 and the seat turn section 2C is reduced.

Assuming that in a structure in which the movable region support section Ao is not provided, the contact section B is in contact with the seat turn section 2C so as to rub against the seat turn section 2C according to the change in load. Thus, if the load is changed repeatedly for years, the seat turn section 2C is rubbed by the contact section B, leading to damage of the protective coating of the seat turn section 2C, and the seat turn section 2C may be damaged early.

In contrast, the spring 1 of this embodiment is provided with a movable region support section Ao, wherein the movable region support section Ao has a widthwise dimension Wo less than or equal to 1.25 times the diameter dimension of the seat turn section 2C. Therefore, the seat section 3 of this embodiment has a structure without the contact section B (see FIG. 3).

Therefore, in the spring 1 of this embodiment, rubbing of the coating layer 2B by the contact section B is suppressed, so that early damage of the spring section 2 can be suppressed.

As can be seen from the above description, the movable section A is a portion of the seat turn section 2C that is greatly displaced due to a change in the load. Therefore, the contact section B is formed at a portion of the seat section 3 corresponding to the movable section A.

In other words, assuming that in a structure in which the movable region support section Ao is not provided, the movable region support section Ao is a portion where there is a contact section B that rubs against the seat turn section 2C according to a change in load.

In addition, the inventors have conducted a test in which the seat section 3 is made of rubber of natural rubber type and the load F is periodically changed in a range of 1650 N to 5200 N. It has been confirmed, from this test that sufficient effects can be obtained in practical applications.

### Other Embodiments

In the above embodiment, the movable region support section Ao is provided at a position corresponding to a portion deviated from the end portion of the seat turn section 2C by 0.55 turns or more. However, the present disclosure is not limited thereto. For example, the movable region support section Ao may be provided in the entire region of the groove section 3A.

The seat section 3 of the above embodiment may be made of rubber of natural rubber type. Additionally, the seat section 3 may be made of rubber other than natural rubber types.

In the seat section 3 of the above embodiment, the lower side of the movable region support section Ao has a widthwise dimension larger than the widthwise dimension of the movable region support section Ao. However, the present disclosure is not limited thereto. For example, the widthwise dimension of the lower side of the movable region support section Ao may be the same as the widthwise dimension of the movable region support section Ao, or the widthwise dimension of the lower side of the movable region support section Ao may be smaller than the widthwise dimension of the movable region support section Ao.

The widthwise dimension Wo of the movable region support section Ao in the above embodiment is less than or equal to 1.25 times the diameter dimension of the wire 2A. However, the present disclosure is not limited thereto. For example, it is provided that the seat section 3 has a structure without the contact section B.

Furthermore, the present disclosure is not limited to the above embodiments, without departing from the technical concept recited in the claims. Therefore, at least two of the above multiple embodiments may be combined.

1. A spring for a suspension device, applicable to a suspension device for a vehicle, comprising:
a spring section made of a coil-shaped wire; and
a seat section made by an elastically deformable material, wherein the seat section is in contact with a seat turn section of the spring section, and bears a load acting on the spring section;
wherein when a direction orthogonal to a direction of the load acting on the spring section is set as a widthwise direction, at least one part of the seat section is provided with a movable region support section which has a widthwise dimension less than or equal to predetermined times a diameter dimension of the wire.

2. The spring for a suspension device according to claim 1, wherein when a portion of the spring section that is deviated from an end portion of the seat turn section by a predetermined distance, is set as a movable section, the movable region support section is provided at least at a portion corresponding to the movable section.

3. The spring for a suspension device according to claim 1, wherein the movable region support section has a widthwise dimension less than or equal to 1.25 times the diameter dimension of the wire.

4. The spring for a suspension device according to claim 1, wherein the movable section comprises a location on the spring section that is deviated from the end portion of the seat turn section by 0.55 turns or more.

5. The spring for a suspension device according to claim 1, wherein a surface of the wire forming the spring section is covered by a coating layer.

6. The spring for a suspension device according to claim 1, wherein the seat section is made of rubber of natural rubber type.

7. A spring for a suspension device, applicable to a suspension device for a vehicle comprising:
a spring section made of a coil-shaped wire; and
a seat section made by an elastically deformable material wherein the seat section has a groove for embedding a seat turn section of the spring section, such that the seat turn section is accommodated in the groove;
wherein the seat section has a sectional shape along a widthwise direction of the groove, and a part of each end of the sectional shape in the widthwise direction is cut off.

8. The spring for a suspension device according to claim 7, wherein the seat section has the sectional shape along the widthwise direction of the groove, and one side of each end of the sectional shape in the widthwise direction is cut off, with the side being opposite to the side contacting the ground.

9. The spring for a suspension device according to claim 7, wherein the seat section has the sectional shape along the widthwise direction of the groove, and a part of each end of the sectional shape in the widthwise direction is cut into a rectangular shape.

10. The spring for a suspension device according to claim 7, wherein the seat section has a stepped sectional shape along the widthwise direction of the groove, and the stepped sectional shape is formed such that a part of each end of the seat section in the widthwise direction is formed as a central recess of the rest part.

11. The spring for a suspension device according to claim 2, wherein the movable region support section has a widthwise dimension less than or equal to 1.25 times the diameter dimension of the wire.

12. The spring for a suspension device according to claim 2, wherein the movable section comprises a location on the spring section that is deviated from the end portion of the seat turn section by 0.55 turns or more.

13. The spring for a suspension device according to claim 3, wherein the movable section comprises a location on the spring section that is deviated from the end portion of the seat turn section by 0.55 turns or more.

14. The spring for a suspension device according to claim 2, wherein a surface of the wire forming the spring section is covered by a coating layer.

15. The spring for a suspension device according to claim 3, wherein a surface of the wire forming the spring section is covered by a coating layer.

16. The spring for a suspension device according to claim 4, wherein a surface of the wire forming the spring section is covered by a coating layer.

17. The spring for a suspension device according to claim 2, wherein the seat section is made of rubber of natural rubber type.

18. The spring for a suspension device according to claim 3, wherein the seat section is made of rubber of natural rubber type.

19. The spring for a suspension device according to claim 4, wherein the seat section is made of rubber of natural rubber type.

20. The spring for a suspension device according to claim 5, wherein the seat section is made of rubber of natural rubber type.
